(19) United States
(12) Patent Application Publication
(10) Pub. No.: US 2026/0171501 A1
(43) Pub. Date: Jun. 18, 2026

(54) ELECTROLYTIC SOLUTION FOR SECONDARY BATTERY, AND SECONDARY BATTERY

(71) Applicant: MURATA MANUFACTURING CO., LTD., Kyoto (JP)

(72) Inventors: Kikou YAMAGUCHI, Kyoto (JP); Yasuyuki MASUDA, Kyoto (JP)

(21) Appl. No.: 19/530,880

(22) Filed: Feb. 5, 2026

Related U.S. Application Data
(63) Continuation of application No. PCT/JP2024/028024, filed on Aug. 6, 2024.

(30) Foreign Application Priority Data
Aug. 9, 2023 (JP) 2023-130082

(51) Int. Cl. H01M 10/0567; H01M 10/0525; H01M 10/0569

(52) U.S. Cl. CPC H01M 10/0567; H01M 10/0525; H01M 10/0569; H01M 2300/0028

(57) ABSTRACT

A secondary battery includes a positive electrode, a negative electrode, and an electrolytic solution. The electrolytic solution includes an anisole compound and a non-aqueous solvent. The anisole compound is represented by Formula (1). A molar ratio of the anisole compound to the non-aqueous solvent is 1.6 or greater.

### CROSS REFERENCE TO RELATED APPLICATIONS

The present application is a continuation of International Application No. PCT/JP2024/028024, filed on Aug. 6, 2024, which claims priority to Japanese Patent Application No. 2023-130082, filed on Aug. 9, 2023, the entire contents of which are incorporated herein by reference.

### BACKGROUND

The present technology relates to an electrolytic solution for a secondary battery, and to a secondary battery.

Various kinds of electronic equipment, including mobile phones, have been widely used. Such widespread use has promoted development of a secondary battery as a power source that is smaller in size and lighter in weight and allows for a higher energy density.

The secondary battery includes a positive electrode, a negative electrode, and an electrolytic solution. A configuration of the secondary battery has been considered in various ways.

For example, a non-aqueous electrolytic solution includes a fluorine-containing organic compound, and a content of the fluorine-containing organic compound in the non-aqueous electrolytic solution is within a range from 0.01 wt % to 20 wt % both inclusive. An electrolytic solution includes dimethoxyethane and anisole, and a mixture ratio (a molar ratio) between dimethoxyethane and anisole is 1:2.

### SUMMARY

The present technology relates to an electrolytic solution for a secondary battery, and to a secondary battery.

Although consideration has been given in various ways regarding a configuration of a secondary battery, a battery characteristic of the secondary battery is not sufficient yet. Accordingly, there is room for improvement in terms of the battery characteristic of the secondary battery.

It is desirable to provide an electrolytic solution for a secondary battery, and a secondary battery each of which makes it possible to achieve a superior battery characteristic.

An electrolytic solution for a secondary battery according to an embodiment of the present technology includes an anisole compound and a non-aqueous solvent. The anisole compound is represented by Formula (1). A molar ratio of the anisole compound to the non-aqueous solvent is 1.6 or greater.

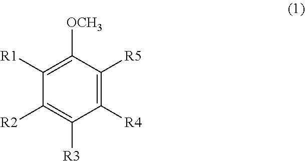

where:
each of R1, R2, R3, R4, and R5 is any one of a hydrogen group, a halogen group, or a halogenated alkyl group; and
at least one of R1, R2, R3, R4, or R5 is either the halogen group or the halogenated alkyl group.

A secondary battery according to an embodiment of the present technology includes a positive electrode, a negative electrode, and an electrolytic solution. The electrolytic solution has a configuration similar to the above-described configuration of the electrolytic solution for the secondary battery according to an embodiment of the present technology.

According to the electrolytic solution for the secondary battery of an embodiment of the present technology, or the secondary battery of an embodiment of the present technology, the electrolytic solution for the secondary battery includes the anisole compound and the non-aqueous solvent, and the molar ratio of the anisole compound to the non-aqueous solvent is 1.6 or greater. This makes it possible to achieve a superior battery characteristic.

Note that effects of the present technology are not necessarily limited to those described herein and may include any of a series of effects described below in relation to the present technology.

### BRIEF DESCRIPTION OF THE FIGURES

FIG. 1 is a perspective diagram illustrating a configuration of a secondary battery according to an embodiment of the present technology.

FIG. 2 is a sectional diagram illustrating, in an enlarged manner, a configuration of a battery device illustrated in FIG. 1.

FIG. 3 is a block diagram illustrating a configuration of an application example of the secondary battery.

### DETAILED DESCRIPTION

The present technology is described below in further detail including with reference to the drawings according to an embodiment.

A description is given first of an electrolytic solution for a secondary battery (hereinafter simply referred to as an “electrolytic solution”) according to an embodiment of the present technology.

The electrolytic solution is a liquid electrolyte to be used in a secondary battery, which is an electrochemical device. However, the electrolytic solution may be used in other electrochemical devices. Other electrochemical devices are not particularly limited in kind, and specific examples thereof include a capacitor.

The electrolytic solution includes a solvent and an electrolyte salt.

The solvent includes an anisole compound represented by Formula (1) and a non-aqueous solvent. Here, the non-aqueous solvent is defined separately from the anisole compound. Therefore, the anisole compound is excluded from the non-aqueous solvent.

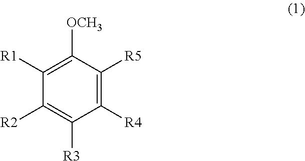

where:
each of R1, R2, R3, R4, and R5 is any one of a hydrogen group, a halogen group, or a halogenated alkyl group; and
at least one of R1, R2, R3, R4, or R5 is either the halogen group or the halogenated alkyl group.

The anisole compound has an anisole-type skeleton, as indicated in Formula (1). Only one anisole compound may be included, or two or more anisole compounds may be included.

Each of R1 to R5 is not particularly limited as long as each of R1 to R5 is any one of a hydrogen group, a halogen group, or a halogenated alkyl group, as described above. Note that R1 to R5 may be the same as each other in kind, or may be different from each other in kind. It goes without saying that any two or more of R1 to R5 may be the same as each other in kind.

However, because each of one or more of R1 to R5 is either the halogen group or the halogenated alkyl group as described above, the anisole compound includes one or more halogens as one or more constituent elements. Accordingly, anisole, which is a compound in which all of R1 to R5 are hydrogen groups, i.e., a compound that does not include one or more halogens as one or more constituent elements, is excluded from the anisole compound described here.

As is apparent from Formula (1), the anisole compound does not include the one or more halogens in a methoxy group (—OCH₃) as one or more constituent elements, but includes the one or more halogens at one or more locations other than the location of the methoxy group.

Each of the one or more halogen groups are not particularly limited in kind, and specific examples thereof include a fluorine group, a chlorine group, a bromine group, and an iodine group.

In particular, the one or more halogen groups preferably include the fluorine group, the chlorine group, or both. One reason for this is that this allows a favorable film including one or more halogens, which are derived from the anisole compound, as one or more constituent elements to be easily formed on a surface of a negative electrode, and thus sufficiently suppresses a decomposition reaction of the electrolytic solution on the surface of the negative electrode.

The halogenated alkyl group is a group corresponding to an alkyl group in which one or more hydrogen groups are substituted with one or more halogen groups. Details of the one or more halogen groups are as described above. The alkyl group may have a straight-chain structure, or may have a branched structure having one or more side chains.

Specific examples of the alkyl group include a methyl group, an ethyl group, a propyl group, a butyl group, a pentyl group, and a hexyl group. Note that the alkyl group may have the straight-chain structure, or may have the branched structure, as described above. Accordingly, for example, the butyl group may be an n-butyl group, a sec-butyl group, an isobutyl group, or a tert-butyl group.

Carbon number of the alkyl group is not particularly limited, and is preferably 5 or less in particular. One reason for this is that this improves solubility and compatibility of the anisole compound.

Specific examples of the anisole compound include respective compounds represented by Formulae (1-1) to (1-10).

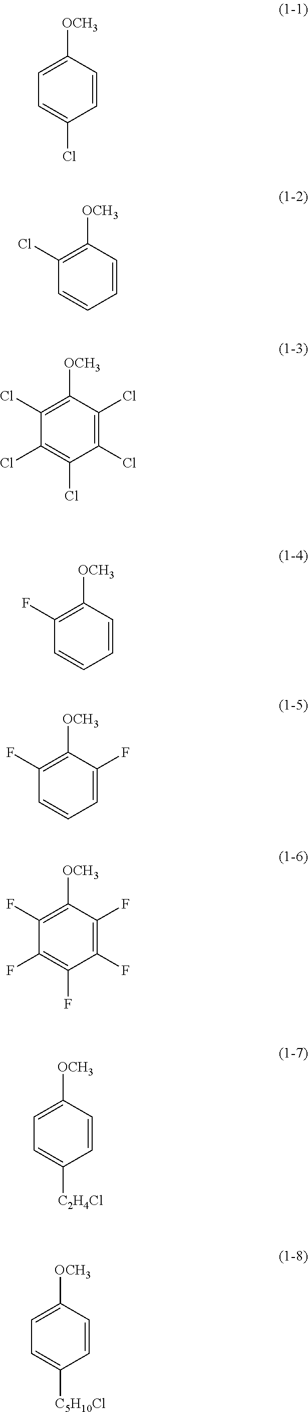

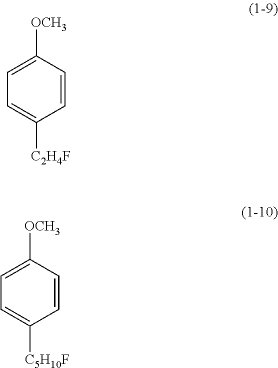

Note that a content of the anisole compound in the electrolytic solution is determined in relation to a content of the non-aqueous solvent in the electrolytic solution, and therefore, a mixture ratio between the anisole compound and the non-aqueous solvent is so determined as to fall within a predetermined range. The mixture ratio between the anisole compound and the non-aqueous solvent described here will be described in detail later.

To confirm that the electrolytic solution includes the anisole compound, the electrolytic solution is analyzed. Although not particularly limited, a method of analyzing the electrolytic solution specifically includes any one or more of methods including, without limitation, inductively coupled plasma (ICP) optical emission spectroscopy, nuclear magnetic resonance (NMR) spectroscopy, and gas chromatography mass spectrometry (GC-MS).

When a secondary battery including the electrolytic solution is used to analyze the electrolytic solution, the secondary battery is disassembled to thereby take out the electrolytic solution, following which the electrolytic solution is analyzed. This allows for identification of a kind of a component, i.e., the anisole compound, included in the electrolytic solution.

The non-aqueous solvent is not particularly limited in kind as long as the non-aqueous solvent is what is called an organic solvent. Only one non-aqueous solvent may be included, or two or more non-aqueous solvents may be included. As described above, the anisole compound is excluded from the non-aqueous solvent described here.

Specifically, the non-aqueous solvent is, for example, an ester or an ether. More specifically, the non-aqueous solvent is, for example, a carbonic-acid-ester-based compound, a carboxylic-acid-ester-based compound, or a lactone-based compound. One reason for this is that this improves a dissociation property of the electrolyte salt and also improves ion mobility.

The carbonic-acid-ester-based compound is, for example, a cyclic carbonic acid ester or a chain carbonic acid ester. Specific examples of the cyclic carbonic acid ester include ethylene carbonate and propylene carbonate, and specific examples of the chain carbonic acid ester include dimethyl carbonate, diethyl carbonate, and ethyl methyl carbonate.

The carboxylic-acid-ester-based compound is, for example, a chain carboxylic acid ester. Specific examples of the chain carboxylic acid ester include ethyl acetate, ethyl propionate, propyl propionate, and ethyl trimethylacetate.

The lactone-based compound is, for example, a lactone. Specific examples of the lactone include γ-butyrolactone and γ-valerolactone.

Note that the ether may be, for example, 1,2-dimethoxyethane, tetrahydrofuran, 1,3-dioxolane, 1,4-dioxane, or anisole.

Examples of the non-aqueous solvent further include an unsaturated cyclic carbonic acid ester, a fluorinated cyclic carbonic acid ester, a sulfonic acid ester, a phosphoric acid ester, an acid anhydride, a nitrile compound, and an isocyanate compound. One reason for this is that this improves electrochemical stability of the electrolytic solution.

Specific examples of the unsaturated cyclic carbonic acid ester include vinylene carbonate, vinyl ethylene carbonate, and methylene ethylene carbonate. Specific examples of the fluorinated cyclic carbonic acid ester include monofluoroethylene carbonate and difluoroethylene carbonate. Specific examples of the sulfonic acid ester include propane sultone and propene sultone. Specific examples of the phosphoric acid ester include trimethyl phosphate and triethyl phosphate. Specific examples of the acid anhydride include succinic anhydride, 1,2-ethanedisulfonic anhydride, and 2-sulfobenzoic anhydride. Specific examples of the nitrile compound include succinonitrile. Specific examples of the isocyanate compound include hexamethylene diisocyanate.

In particular, the non-aqueous solvent preferably includes the carbonic-acid-ester-based compound, the ether, or both. One reason for this is that this allows the secondary battery including the electrolytic solution to obtain a high battery capacity.

In particular, each of the carbonic-acid-ester-based compound and the ether is preferably not a cyclic compound but a chain compound. One reason for this is that this decreases viscosity of the electrolytic solution and improves a degree of solubility of the electrolyte salt. Specific examples of the carbonic-acid-ester-based compound that is the chain compound include the chain carbonic acid ester described above, and specific examples of the ether that is the chain compound include 1,2-dimethoxy ethane described above.

Note that a method of confirming that the electrolytic solution includes the non-aqueous solvent is similar to the method of confirming that the electrolytic solution includes the anisole compound.

As described above, the mixture ratio between the anisole compound and the non-aqueous solvent is so determined as to fall within the predetermined range.

Specifically, a molar ratio that is the mixture ratio of the anisole compound to the non-aqueous solvent is 1.6 or greater. For example, when the content of the non-aqueous solvent in the electrolytic solution is 1 mol, the content of the anisole compound in the electrolytic solution is 1.6 mol or greater.

The molar ratio is calculated based on the following calculation expression: [amount of substance of anisole compound (mol)/amount of substance of non-aqueous solvent (mol)]. Note that the value of the molar ratio is rounded to one decimal place.

One reason why the electrolytic solution includes the anisole compound and the non-aqueous solvent, and the molar ratio is 1.6 or greater is that this allows the mixture ratio between the anisole compound and the non-aqueous solvent to be appropriate, and thus suppresses the decomposition reaction of the electrolytic solution upon charging and discharging of the secondary battery including the electrolytic solution.

More specifically, the anisole compound has a property of not easily coordinating to an alkali metal ion, as compared with the non-aqueous solvent. The alkali metal ion is derived from a cation included in the electrolyte salt. More specifically, the alkali metal ion is, for example, a lithium ion to be described later. For the reason described above, in the electrolytic solution, the non-aqueous solvent easily coordinates to the alkali metal ion, whereas the anisole compound does not easily coordinate to the alkali metal ion.

It is known that the non-aqueous solvent coordinating to the alkali metal ion is easily reduced and decomposed, as compared with the non-aqueous solvent not coordinating to the alkali metal ion. An anion included in the electrolyte salt also has a tendency similar to the above-described tendency regarding reductive decomposition of the non-aqueous solvent. In contrast, because the anisole compound does not easily coordinate to the alkali metal ion as described above, the anisole compound is not easily reduced and decomposed.

Accordingly, because each of the non-aqueous solvent and the anion is easily reduced and decomposed while the anisole compound is not easily reduced and decomposed, it is possible to adjust an electrochemical state of a film to be formed on the surface of the negative electrode by changing a kind of each of the non-aqueous solvent and the anion The film will be described later.

In addition, the anisole compound includes one or more halogens as one or more constituent elements, as described above. Accordingly, when the anisole compound is decomposed upon charging and discharging of the secondary battery, a favorable film including the one or more halogens as one or more constituent elements is formed on the surface of the negative electrode. Therefore, the surface of the negative electrode is electrochemically protected by using the film. For such a reason, even if the negative electrode has high reactivity, the decomposition reaction of the electrolytic solution on the surface of the negative electrode is suppressed.

Accordingly, because the mixture ratio between the anisole compound and the non-aqueous solvent is made appropriate as described above, the decomposition reaction of the electrolytic solution is suppressed upon charging and discharging of the secondary battery including the electrolytic solution.

In particular, the molar ratio is preferably 2.0 or greater. One reason for this is that this further suppresses the decomposition reaction of the electrolytic solution upon the charging and discharging of the secondary battery.

The electrolyte salt includes any one or more of light metal salts including, without limitation, a lithium salt.

Specific examples of the lithium salt include lithium hexafluorophosphate (LiPF₆), lithium tetrafluoroborate (LiBF₄), lithium trifluoromethanesulfonate (LiCF₃SO₃), lithium bis(fluorosulfonyl)imide (LiN(FSO₂)₂), lithium bis(trifluoromethanesulfonyl)imide (LiN(CF₃SO₂)₂), lithium tris(trifluoromethanesulfonyl) methide (LiC(CF₃SO₂)₃), lithium bis(oxalato) borate (LiB(C₂O₄)₂), lithium monofluorophosphate (Li₂PFO₃), and lithium difluorophosphate (LiPF₂O₂). One reason for this is that a high battery capacity is obtainable.

A content of the electrolyte salt is not particularly limited, and is specifically within a range from 0.3 mol/kg to 3.0 mol/kg both inclusive with respect to the solvent. One reason for this is that this allows for high ion conductivity.

To manufacture the electrolytic solution, the electrolyte salt is put into the solvent including the anisole compound and the non-aqueous solvent. In this case, the mixture ratio between the anisole compound and the non-aqueous solvent is so adjusted that the molar ratio falls within the above-described range. The electrolyte salt is thereby dispersed or dissolved in the solvent. The electrolytic solution is thus prepared.

According to the electrolytic solution described above, the electrolytic solution includes the anisole compound and the non-aqueous solvent, and the molar ratio is 1.6 or greater.

In this case, as described above, the mixture ratio between the anisole compound and the non-aqueous solvent is made appropriate. Therefore, owing to a difference between properties of the anisole compound and properties of the non-aqueous solvent, a favorable film is formed on the surface of the negative electrode upon charging and discharging of the secondary battery including the electrolytic solution. The surface of the negative electrode is thus electrochemically protected by using the film, and the decomposition reaction of the electrolytic solution on the surface of the negative electrode is therefore suppressed. Accordingly, the decomposition reaction of the electrolytic solution is suppressed upon charging and discharging of the secondary battery. It is thus possible to achieve a secondary battery having a superior battery characteristic by using such an electrolytic solution.

In particular, the molar ratio may be 2.0 or greater. This further suppresses the decomposition reaction of the electrolytic solution upon the charging and discharging of the secondary battery. Accordingly, it is possible to achieve higher effects.

Further, the halogen group may include a fluorine group, a chlorine group, or both. This sufficiently suppresses the decomposition reaction of the electrolytic solution. Accordingly, it is possible to achieve higher effects.

Further, the carbon number of the halogenated alkyl group may be 5 or less. This improves the solubility and the compatibility of the anisole compound. Accordingly, it is possible to achieve higher effects.

Further, the non-aqueous solvent may include the carbonic-acid-ester-based compound, the ether, or both. This makes it possible to obtain a high battery capacity in the secondary battery. Accordingly, it is possible to achieve higher effects. In this case, each of the carbonic-acid-ester-based compound and the ether may be the chain compound. This decreases the viscosity of the electrolytic solution and improves the degree of solubility of the electrolyte salt. Accordingly, it is possible to achieve even higher effects.

A description is given next of a secondary battery including the electrolytic solution described above.

The secondary battery to be described here is a secondary battery in which a battery capacity is obtained through insertion and extraction of an electrode reactant, and includes a positive electrode, a negative electrode, and an electrolytic solution.

Although not particularly limited in kind, the electrode reactant is specifically a light metal such as an alkali metal or an alkaline earth metal. Specific examples of the alkali metal include lithium, sodium, and potassium. Specific examples of the alkaline earth metal include beryllium, magnesium, and calcium.

The following description deals with an example case where the electrode reactant is lithium. A secondary battery in which the battery capacity is obtained through insertion and extraction of lithium is what is called a lithium secondary battery or a lithium-ion secondary battery. In the lithium secondary battery, lithium is inserted and extracted in an ionic state.

Note that a charge capacity of the negative electrode is preferably greater than a discharge capacity of the positive electrode. In other words, an electrochemical capacity per unit area of the negative electrode is preferably greater than an electrochemical capacity per unit area of the positive electrode. This is to suppress precipitation of the electrode reactant on a surface of the negative electrode during charging.

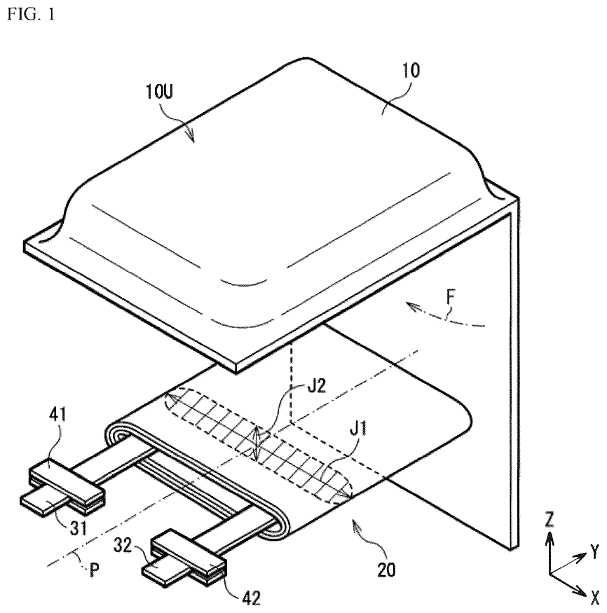

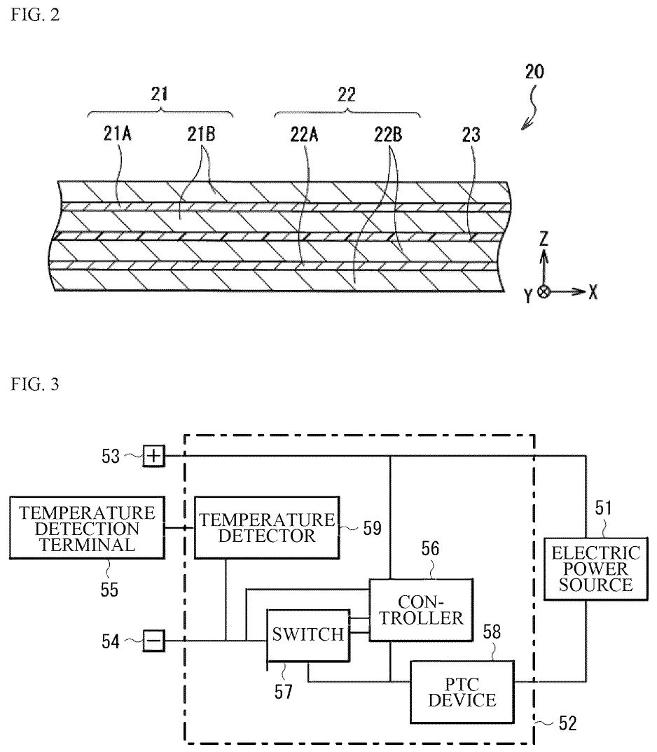

FIG. 1 illustrates a perspective configuration of the secondary battery. FIG. 2 illustrates, in an enlarged manner, a sectional configuration of a battery device 20 illustrated in FIG. 1.

Note that FIG. 1 illustrates a state in which an outer package film 10 and the battery device 20 are separated from each other, and indicates a section of the battery device 20 along an XZ plane by a dashed line. FIG. 2 illustrates only a part of the battery device 20.

As illustrated in FIGS. 1 and 2, the secondary battery includes the outer package film 10, the battery device 20, a positive electrode lead 31, a negative electrode lead 32, and sealing films 41 and 42.

The secondary battery described here includes the outer package film 10 as an outer package member to contain the battery device 20, as described above. Accordingly, the secondary battery illustrated in FIG. 1 is a secondary battery of what is called a laminated-film type.

As illustrated in FIG. 1, the outer package film 10 is an outer package member having flexibility or softness, and has a pouch-shaped structure that is sealed in a state where the battery device 20 is contained in the outer package film 10. The outer package film 10 thus contains a positive electrode 21, a negative electrode 22, a separator 23, and an electrolytic solution (not illustrated). The positive electrode 21, the negative electrode 22, and the separator 23 will be described later.

Here, the outer package film 10 is a single film-shaped member and is folded toward a folding direction F. The outer package film 10 has a depression part 10U to place the battery device 20 therein. The depression part 10U is what is called a deep drawn part.

Specifically, the outer package film 10 is a three-layered laminated film including a fusion-bonding layer, a metal layer, and a surface protective layer stacked in this order from an inner side. In a state in which the outer package film 10 is folded, outer edge parts of the fusion-bonding layer opposed to each other are fusion-bonded to each other. The fusion-bonding layer includes a polymer compound such as polypropylene. The metal layer includes a metal material such as aluminum. The surface protective layer includes a polymer compound such as nylon.

Note that the outer package film 10 is not particularly limited in configuration or the number of layers, and may be single-layered or two-layered, or may include four or more layers.

The battery device 20 is contained in the outer package film 10. The battery device 20 is what is called a power generation device, and includes, as illustrated in FIGS. 1 and 2, the positive electrode 21, the negative electrode 22, the separator 23, and the electrolytic solution (not illustrated).

Here, the battery device 20 is what is called a wound electrode body. Therefore, the positive electrode 21 and the negative electrode 22 are wound about a winding axis P, being opposed to each other with the separator 23 interposed therebetween. As illustrated in FIG. 1, the winding axis P is a virtual axis extending in a Y-axis direction.

The battery device 20 is not particularly limited in three-dimensional shape. Here, the battery device 20 has an elongated three-dimensional shape. Accordingly, a section of the battery device 20 intersecting the winding axis P, that is, the section of the battery device 20 along the XZ plane, has an elongated shape defined by a major axis J1 and a minor axis J2.

The major axis J1 is a virtual axis that extends in an X-axis direction and has a length larger than a length of the minor axis J2. The minor axis J2 is a virtual axis that extends in a Z-axis direction intersecting the X-axis direction and has the length smaller than the length of the major axis J1. Here, the battery device 20 has an elongated cylindrical three-dimensional shape. Thus, the section of the battery device 20 has an elongated, substantially elliptical shape.

The positive electrode 21 includes, as illustrated in FIG. 2, a positive electrode current collector 21A and a positive electrode active material layer 21B. Note, however, that the positive electrode current collector 21A may be omitted.

The positive electrode current collector 21A has two opposed surfaces on each of which the positive electrode active material layer 21B is to be provided. The positive electrode current collector 21A includes an electrically conductive material such as a metal material. Specific examples of the electrically conductive material include aluminum.

The positive electrode active material layer 21B includes any one or more of positive electrode active materials which lithium is to be inserted into and extracted from. Note that the positive electrode active material layer 21B may further include any one or more of other materials. Examples of the other materials include a positive electrode binder and a positive electrode conductor. A method of forming the positive electrode active material layer 21B is not particularly limited, and is specifically a method such as a coating method.

Here, the positive electrode active material layer 21B is provided on each of the two opposed surfaces of the positive electrode current collector 21A. However, the positive electrode active material layer 21B may be provided only on one of the two opposed surfaces of the positive electrode current collector 21A on a side where the positive electrode 21 is opposed to the negative electrode 22.

The positive electrode active material is not particularly limited in kind, and specific examples thereof include a lithium-containing compound. The lithium-containing compound is a compound that includes lithium and one or more transition metal elements as constituent elements. The lithium-containing compound may further include one or more other elements as one or more constituent elements. The one or more other elements are not particularly limited in kind as long as the one or more other elements are each an element other than lithium and the transition metal elements. Specifically, the one or more other elements are any one or more of elements belonging to groups 2 to 15 in the long period periodic table. The lithium-containing compound is not particularly limited in kind, and is specifically, for example, an oxide, a phosphoric acid compound, a silicic acid compound, and a boric acid compound.

Specific examples of the oxide include LiNiO₂, LiCoO₂, LiCo_{0.98}Al_{0.01}Mg_{0.01}O₂, LiNi_{0.5}Co_{0.2}Mn_{0.3}O₂, LiNi_{0.5}CO_{0.15}Al_{0.05}O₂, LiNi_{0.33}Co_{0.33}Mn_{0.33}O₂, Li_{1.2}Mn_{0.52}Co_{0.175}Ni_{0.1}O₂, Li_{1.15}(Mn_{0.65}Ni_{0.22}Co_{0.13})O₂, and LiMn₂O₄. Specific examples of the phosphoric acid compound include LiFePO₄, LiMnPO₄, LiFe_{0.5}Mn_{0.5}PO₄, and LiFe_{0.3}Mn_{0.7}PO₄.

The positive electrode binder includes any one or more of materials including, without limitation, a synthetic rubber and a polymer compound. Specific examples of the synthetic rubber include a styrene-butadiene-based rubber, a fluorine-based rubber, and ethylene propylene diene. Specific examples of the polymer compound include polyvinylidene difluoride, polyimide, and carboxymethyl cellulose.

The positive electrode conductor includes any one or more of electrically conductive materials including, without limitation, a carbon material, a metal material, and an electrically conductive polymer compound. Specific examples of the carbon material include graphite, carbon black, acetylene black, and Ketjen black.

The negative electrode 22 includes, as illustrated in FIG. 2, a negative electrode current collector 22A and a negative electrode active material layer 22B. Note, however, that the negative electrode current collector 22A may be omitted.

The negative electrode current collector 22A has two opposed surfaces on each of which the negative electrode active material layer 22B is to be provided. The negative electrode current collector 22A includes an electrically conductive material such as a metal material. Specific examples of the electrically conductive material include copper.

The negative electrode active material layer 22B includes any one or more of negative electrode active materials which lithium is to be inserted into and extracted from. Note that the negative electrode active material layer 22B may further include any one or more of other materials. Examples of the other materials include a negative electrode binder and a negative electrode conductor. A method of forming the negative electrode active material layer 22B is not particularly limited, and specifically includes any one or more of methods including, without limitation, a coating method, a vapor-phase method, a liquid-phase method, a thermal spraying method, and a firing (sintering) method.

Here, the negative electrode active material layer 22B is provided on each of the two opposed surfaces of the negative electrode current collector 22A. However, the negative electrode active material layer 22B may be provided only on one of the two opposed surfaces of the negative electrode current collector 22A on a side where the negative electrode 22 is opposed to the positive electrode 21.

The negative electrode active material is not particularly limited in kind, and specific examples thereof include a carbon material and a metal-based material. One reason for this is that a high energy density is obtainable.

Specific examples of the carbon material include graphitizable carbon, non-graphitizable carbon, and graphite. The graphite may include natural graphite, artificial graphite, or both.

The term “metal-based material” is a generic term for materials each including, as one or more constituent elements, any one or more elements among metal elements and metalloid elements that are each able to form an alloy with lithium. Specific examples of such metal elements and metalloid elements include silicon and tin. The metal-based material may be a simple substance, an alloy, a compound, a mixture of two or more thereof, or a material including two or more phases thereof. Note that the simple substance may include any amount of impurity. Specific examples of the metal-based material include TiSi₂ and SiOₓ (0<x≤2 or 0.2<x<1.4).

Details of the negative electrode binder are similar to those of the positive electrode binder. Details of the negative electrode conductor are similar to those of the positive electrode conductor.

The separator 23 is an insulating porous film interposed between the positive electrode 21 and the negative electrode 22 as illustrated in FIG. 2, and allows lithium to pass therethrough in an ionic state while preventing occurrence of a short circuit to be caused by contact between the positive electrode 21 and the negative electrode 22. The separator 23 includes any one or more of insulating polymer compounds. Specific examples of the insulating polymer compounds include polyethylene.

The positive electrode 21, the negative electrode 22, and the separator 23 are each impregnated with the electrolytic solution, and the electrolytic solution has the configuration described above. That is, the electrolytic solution includes the anisole compound and the non-aqueous solvent, and the molar ratio is 1.6 or greater.

As illustrated in FIGS. 1 and 2, the positive electrode lead 31 is a positive electrode wiring coupled to the positive electrode current collector 21A of the positive electrode 21, and is led to an outside of the outer package film 10. The positive electrode lead 31 includes any one or more of electrically conductive materials including, without limitation, a metal material. Specific examples of the electrically conductive material include aluminum. The positive electrode lead 31 has any one of shapes including, without limitation, a thin plate shape and a meshed shape.

As illustrated in FIGS. 1 and 2, the negative electrode lead 32 is a negative electrode wiring coupled to the negative electrode current collector 22A of the negative electrode 22, and is led to the outside of the outer package film 10. Here, the negative electrode lead 32 is led toward a direction similar to that in which the positive electrode lead 31 is led out. The negative electrode lead 32 includes any one or more of electrically conductive materials including, without limitation, a metal material. Specific examples of the electrically conductive material include copper. Details of a shape of the negative electrode lead 32 are similar to those of the shape of the positive electrode lead 31.

The sealing film 41 is disposed between the outer package film 10 and the positive electrode lead 31, as illustrated in FIG. 1. The sealing film 42 is disposed between the outer package film 10 and the negative electrode lead 32, as illustrated in FIG. 1. Note that the sealing film 41, the sealing film 42, or both may be omitted.

The sealing film 41 is a sealing member that prevents entry of, for example, outside air into the outer package film 10. The sealing film 41 includes a polymer compound such as a polyolefin that has adherence to the positive electrode lead 31. Specific examples of the polymer compound include polypropylene.

The sealing film 42 has a configuration similar to that of the sealing film 41 except that the sealing film 42 is a sealing member that has adherence to the negative electrode lead 32. That is, the sealing film 42 includes a polymer compound such as a polyolefin that has adherence to the negative electrode lead 32.

The secondary battery operates as described below in the battery device 20.

Upon charging, lithium is extracted from the positive electrode 21, and the extracted lithium is inserted into the negative electrode 22 via the electrolytic solution. Upon discharging, lithium is extracted from the negative electrode 22, and the extracted lithium is inserted into the positive electrode 21 via the electrolytic solution. Upon each of the discharging and the charging, lithium is inserted and extracted in an ionic state.

To manufacture the secondary battery, each of the positive electrode 21 and the negative electrode 22 is fabricated, following which the secondary battery is assembled and the assembled secondary battery is subjected to a stabilization process, according to an example procedure to be described below.

Note that the manufacturing method of the electrolytic solution is not described below because it has already been described above.

First, the positive electrode active material, the positive electrode binder, and the positive electrode conductor are mixed with each other to thereby obtain a positive electrode mixture. Thereafter, the positive electrode mixture is put into a solvent to thereby prepare a positive electrode mixture slurry in paste form. The solvent may be an aqueous solvent, or may be an organic solvent.

Lastly, the positive electrode mixture slurry is applied on the two opposed surfaces of the positive electrode current collector 21A to thereby form the positive electrode active material layers 21B. Thereafter, the positive electrode active material layers 21B may be compression-molded by a compression device such as a roll pressing machine. In this case, the positive electrode active material layers 21B may be heated. The positive electrode active material layers 21B may be compression-molded multiple times. The positive electrode active material layers 21B are thus formed on the two respective opposed surfaces of the positive electrode current collector 21A. As a result, the positive electrode 21 is fabricated.

The negative electrode 22 is formed by a procedure similar to the fabrication procedure of the positive electrode 21 described above. Specifically, a mixture (a negative electrode mixture) in which the negative electrode active material, the negative electrode binder, and the negative electrode conductor are mixed with each other is put into a solvent to thereby prepare a negative electrode mixture slurry in paste form. Details of the solvent are as described above. Thereafter, the negative electrode mixture slurry is applied on the two opposed surfaces of the negative electrode current collector 22A to thereby form the negative electrode active material layers 22B. Thereafter, the negative electrode active material layers 22B may be compression-molded. Details of the compression molding are as described above. The negative electrode active material layers 22B are thus formed on the two respective opposed surfaces of the negative electrode current collector 22A. As a result, the negative electrode 22 is fabricated.

First, the positive electrode lead 31 is coupled to the positive electrode current collector 21A of the positive electrode 21 by a joining method such as a welding method, and the negative electrode lead 32 is coupled to the negative electrode current collector 22A of the negative electrode 22 by the joining method such as the welding method.

Thereafter, the positive electrode 21 and the negative electrode 22 are stacked on each other with the separator 23 interposed therebetween to thereby form a stacked body (not illustrated). Thereafter, the stacked body is wound to thereby fabricate a wound body (not illustrated), following which the wound body is pressed by a compression device such as a pressing machine to thereby shape the wound body into an elongated shape. The shaped wound body has a configuration similar to the configuration of the battery device 20 except that the positive electrode 21, the negative electrode 22, and the separator 23 are each not impregnated with the electrolytic solution.

Thereafter, the wound body is placed in the depression part 10U, following which the outer package film 10 (the fusion-bonding layer/the metal layer/the surface protective layer) is folded to thereby cause parts of the outer package film 10 to be opposed to each other. Thereafter, outer edge parts of two sides of the fusion-bonding layer opposed to each other are bonded to each other by a bonding method such as a thermal-fusion-bonding method to thereby allow the wound body to be contained in the outer package film 10 having a pouch shape.

Lastly, the electrolytic solution is injected into the outer package film 10 having the pouch shape, following which outer edge parts of the remaining one side of the fusion-bonding layer opposed to each other are bonded to each other by the bonding method such as the thermal-fusion-bonding method. In this case, the sealing film 41 is interposed between the outer package film 10 and the positive electrode lead 31, and the sealing film 42 is interposed between the outer package film 10 and the negative electrode lead 32.

The wound body is thereby impregnated with the electrolytic solution, and the battery device 20 is thus fabricated. Accordingly, the battery device 20 is sealed in the outer package film 10 having the pouch shape. The secondary battery is thus assembled.

The assembled secondary battery is charged and discharged. Stabilization conditions including, for example, an environment temperature, the number of times of charging and discharging (the number of cycles), and charging and discharging conditions may be set as desired.

A film is thereby formed on the surface of each of the positive electrode 21 and the negative electrode 22. In this case, a film derived from the anisole compound is formed on the surface of the negative electrode 22, as described above.

As a result, the battery device 20 is brought into an electrochemically stable state, and the secondary battery is thus completed.

According to the secondary battery described above, the electrolytic solution has the above-described configuration. Accordingly, for the above-described reasons, the decomposition reaction of the electrolytic solution is suppressed upon charging and discharging of the secondary battery. It is thus possible to achieve a superior battery characteristic.

In particular, the secondary battery may include a lithium secondary battery. This makes it possible to obtain a sufficient battery capacity stably through insertion and extraction of lithium. Accordingly, it is possible to achieve higher effects.

Other action and effects of the secondary battery are similar to those of the electrolytic solution described above.

Next, modification examples will be described. The configuration of the secondary battery is appropriately modifiable including as described below according to an embodiment. Note that any of the following series of modification examples may be combined with each other.

Described above is the case where the negative electrode 22 includes the negative electrode active material which lithium is to be inserted into and extracted from and the secondary battery is therefore a lithium secondary battery using insertion and extraction of lithium, i.e., what is called a lithium-ion secondary battery. However, although not specifically illustrated here, the secondary battery may be a secondary battery that uses precipitation and dissolution of lithium, i.e., what is called a lithium-metal secondary battery.

The secondary battery to be described here has a configuration similar to the above-described configuration of the secondary battery except that the negative electrode 22 includes a simple substance of lithium, i.e., what is called a lithium metal. Specifically, the negative electrode 22 is, for example, a lithium metal foil. Note that the lithium metal may include any amount of impurity.

In the secondary battery, upon charging, lithium is extracted from the positive electrode 21 in an ionic state, and the lithium metal is precipitated on the surface of the negative electrode 22. In the secondary battery, upon discharging, the lithium metal is eluted from the negative electrode 22, and lithium is inserted into the positive electrode 21 in an ionic state.

A manufacturing method of this secondary battery is similar to the manufacturing method of the above-described secondary battery except that the lithium metal is used as the negative electrode 22.

In this secondary battery also, the battery capacity is obtainable through precipitation and dissolution of lithium. Accordingly, it is possible to achieve similar effects.

The separator 23 that is a porous film is used. However, although not specifically illustrated here, a separator of a stacked type including a polymer compound layer may be used.

Specifically, the separator of the stacked type includes a porous film and the polymer compound layer. The porous film has two opposed surfaces, and the polymer compound layer is provided on one of or each of the two opposed surfaces of the porous film. One reason for this is that this improves adherence of the separator to each of the positive electrode 21 and the negative electrode 22, and thus suppresses misalignment of the battery device 20. This suppresses winding displacement of each of the positive electrode 21, the negative electrode 22, and the separator 23, and thus suppresses swelling of the secondary battery even if the decomposition reaction of the electrolytic solution occurs. The polymer compound layer includes, for example, polyvinylidene difluoride. One reason for this is that polyvinylidene difluoride is superior in physical strength and is electrochemically stable.

Note that the porous film, the polymer compound layer, or both may include any one or more kinds of insulating particles. One reason for this is that the insulating particles dissipate heat upon heat generation by the secondary battery, thus improving safety or heat resistance of the secondary battery. The insulating particles include any one or more of insulating materials including, without limitation, an inorganic material and a resin material. Specific examples of the inorganic material include aluminum oxide, aluminum nitride, boehmite, silicon oxide, titanium oxide, magnesium oxide, and zirconium oxide. Specific examples of the resin material include acrylic resin and styrene resin.

To fabricate the separator of the stacked type, a precursor solution including, without limitation, the polymer compound and an organic solvent is prepared, following which the precursor solution is applied on one of or each of the two opposed surfaces of the porous film. In this case, the precursor solution may include the insulating particles.

When the separator of the stacked type is used also, lithium is movable in an ionic state between the positive electrode 21 and the negative electrode 22, and similar effects are therefore achievable. In this case, in particular, the swelling of the secondary battery is further suppressed, as described above. Accordingly, it is possible to achieve higher effects.

The electrolytic solution, which is a liquid electrolyte, is used. However, although not specifically illustrated here, an electrolyte layer, which is a gel electrolyte, may be used.

In the battery device 20 including the electrolyte layer, the positive electrode 21 and the negative electrode 22 are wound, being opposed to each other with the separator 23 and the electrolyte layer interposed therebetween. The electrolyte layer is interposed between the positive electrode 21 and the separator 23, and between the negative electrode 22 and the separator 23.

Specifically, the electrolyte layer includes a polymer compound together with the electrolytic solution. The electrolytic solution is held by the polymer compound. One reason for this is that this prevents leakage of the electrolytic solution. The configuration of the electrolytic solution is as described above. The polymer compound includes, for example, polyvinylidene difluoride. To form the electrolyte layer, a precursor solution including the electrolytic solution, the polymer compound, and a solvent is prepared, following which the precursor solution is applied on one side or both sides of the positive electrode 21 and on one side or both sides of the negative electrode 22.

When the electrolyte layer is used also, lithium is movable in an ionic state between the positive electrode 21 and the negative electrode 22 via the electrolyte layer, and similar effects are therefore achievable. In this case, in particular, the leakage of the electrolytic solution is prevented, as described above. Accordingly, it is possible to achieve higher effects.

A description is given of applications (application examples) of the secondary battery according to an embodiment.

The applications of the secondary battery are not particularly limited. The secondary battery used as a power source may serve as a main power source or an auxiliary power source in, for example, electronic equipment and an electric vehicle. The main power source is preferentially used regardless of the presence of any other power source. The auxiliary power source may be used in place of the main power source, or may be switched from the main power source.

Specific examples of the applications of the secondary battery include: electronic equipment; apparatuses for data storage; electric power tools; battery packs to be mounted on, for example, electronic equipment; medical electronic equipment; electric vehicles; and electric power storage systems. Examples of the electronic equipment include video cameras, digital still cameras, mobile phones, laptop personal computers, headphone stereos, portable radios, and portable information terminals. Examples of the apparatuses for data storage include backup power sources and memory cards. Examples of the electric power tools include electric drills and electric saws. Examples of the medical electronic equipment include pacemakers and hearing aids. Examples of the electric vehicles include electric automobiles including hybrid automobiles. Examples of the electric power storage systems include battery systems for home use or industrial use in which electric power is accumulated for a situation such as emergency. In each of the above-described applications, one secondary battery may be used, or multiple secondary batteries may be used.

The battery pack may include a battery cell, or may include an assembled battery. The electric vehicle is a vehicle that travels with the secondary battery as a driving power source, and may be a hybrid automobile that is additionally provided with a driving source other than the secondary battery. In an electric power storage system for home use, electric power accumulated in the secondary battery serving as an electric power storage source may be utilized for using, for example, home appliances.

An application example of the secondary battery will now be described in detail. The configuration described below is merely an example, and is appropriately modifiable.

FIG. 3 illustrates a block configuration of a battery pack as the application example of the secondary battery. The battery pack described here is a battery pack (what is called a soft pack) including one secondary battery, and is to be mounted on, for example, electronic equipment typified by a smartphone.

As illustrated in FIG. 3, the battery pack includes an electric power source 51 and a circuit board 52. The circuit board 52 is coupled to the electric power source 51, and includes a positive electrode terminal 53, a negative electrode terminal 54, and a temperature detection terminal 55.

The electric power source 51 includes one secondary battery. The secondary battery has a positive electrode lead coupled to the positive electrode terminal 53 and a negative electrode lead coupled to the negative electrode terminal 54. The electric power source 51 is couplable to outside via the positive electrode terminal 53 and the negative electrode terminal 54, and is thus chargeable and dischargeable. The circuit board 52 includes a controller 56, a switch 57, a PTC device 58 as a thermosensitive resistive device, and a temperature detector 59. Note that the PTC device 58 may be omitted.

The controller 56 includes, for example, a central processing unit (CPU) and a memory, and controls an overall operation of the battery pack. The controller 56 performs, for example, detection and control of a use state of the electric power source 51.

If a voltage of the electric power source 51 (the secondary battery) reaches an overcharge detection voltage or an overdischarge detection voltage, the controller 56 turns off the switch 57. This prevents a charging current from flowing into a current path of the electric power source 51. The overcharge detection voltage is not particularly limited and is specifically 4.20 V±0.05 V. The overdischarge detection voltage is not particularly limited and is specifically 2.40 V±0.10 V.

The switch 57 includes, for example, a charge control switch, a discharge control switch, a charging diode, and a discharging diode. The switch 57 performs switching between coupling and decoupling between the electric power source 51 and external equipment in accordance with an instruction from the controller 56. The switch 57 includes, for example, a metal-oxide-semiconductor field-effect transistor (MOSFET). Each of the charging current and the discharging current is detected based on an ON-resistance of the switch 57.

The temperature detector 59 includes a temperature detection device such as a thermistor. The temperature detector 59 measures a temperature of the electric power source 51 through the temperature detection terminal 55, and outputs a result of the temperature measurement to the controller 56. The result of the temperature measurement to be obtained by the temperature detector 59 is used, for example, when the controller 56 performs charge and discharge control upon abnormal heat generation or when the controller 56 performs a correction process upon calculating a remaining capacity.

### EXAMPLES

A description is given of Examples of the present technology according to an embodiment.

### Examples 1 to 7 and Comparative Examples 1 to 10

Secondary batteries were manufactured, following which the secondary batteries were each evaluated for a battery characteristic as described below.

### [Fabrication of Secondary Battery]

Here, test secondary batteries were each fabricated to conduct a simple evaluation for a battery characteristic in accordance with the following procedure. The test secondary batteries were each a simple lithium-metal secondary battery.

First, the anisole compound and the non-aqueous solvent were mixed with each other to thereby obtain the solvent.

Used as the anisole compounds were the compound represented by Formula (1-1), the compound represented by Formula (1-2), the compound represented by Formula (1-4), the compound represented by Formula (1-5), and the compound represented by Formula (1-7). Used as the non-aqueous solvent was 1,2-dimethoxy ethane (DME). To obtain the solvent, the molar ratio was varied as indicated in Table 1 by changing the mixture ratio between the anisole compound and the non-aqueous solvent.

Thereafter, the electrolyte salt (lithium bis(fluorosulfonyl)imide) was put into the solvent, following which the solvent was stirred to prepare the electrolytic solution (Examples 1 to 7 and Comparative examples 1 to 8). In this case, the content of the electrolyte salt was set to 2 mol/l (=1 mol/dm³) with respect to the solvent.

An electrolytic solution for comparison was prepared by a similar procedure, except that no anisole compound was included and only the non-aqueous solvent was included as the solvent, as indicated in Table 1 (Comparative examples 9 and 10). Used as the non-aqueous solvents were 1,2-dimethoxy ethane and anisole (ANS).

Thereafter, a lithium metal foil (having a thickness of 0.1 mm) was compression-bonded to a copper foil (having a thickness of 0.01 mm) by using a pressing machine to fabricate a test electrode.

Thereafter, the electrolytic solution was dropped onto the separator (a fine porous polyethylene film having a thickness of 10 μm) to thereby impregnate the separator with the electrolytic solution. An amount of the dropped electrolytic solution was 0.01 ml (=0.01 cm³).

Thereafter, a copper foil (having a thickness of 0.012 mm) was prepared as a counter electrode, following which the test electrode and the counter electrode were stacked on each other with the separator impregnated with the electrolytic solution interposed therebetween. The test electrode and the counter electrode were thus stacked on each other with the separator impregnated with the electrolytic solution interposed therebetween. As a result, the test secondary battery was completed.

### [Evaluation of Battery Characteristic]

The secondary batteries were each evaluated for the battery characteristic, and the evaluation revealed the results presented in Table 1.

Here, a charge and discharge characteristic was evaluated as the battery characteristic to examine reversibility of precipitation and dissolution of lithium on a surface of the counter electrode.

To evaluate the charge and discharge characteristic, first, the secondary battery was charged in an ambient temperature environment (at a temperature of 23° C.) to thereby measure a charge capacity, following which the secondary battery was discharged to thereby measure a discharge capacity.

Upon charging, the secondary battery was charged at a current density of 0.22 mA/cm² until a total charge time reached three hours. Upon discharging, the secondary battery was discharged until a voltage reached 0.1 V.

Thereafter, coulombic efficiency was calculated based on the following calculation expression: coulombic efficiency (%)=(discharge capacity/charge capacity)×100.

Thereafter, the secondary battery was repeatedly charged and discharged in the same environment and the coulombic efficiency was calculated for each cycle until the total number of cycles reached 25. The charging and discharging conditions were as described above.

Lastly, an average value of 16 respective values of the coulombic efficiency calculated in the 10th cycle to the 25th cycle was calculated to thereby obtain average coulombic efficiency (%) as an index for evaluating the charge and discharge characteristic. The value of the average coulombic efficiency was a value rounded to one decimal place.

One reason why nine values of the coulombic efficiency calculated in earlier cycles of charging and discharging (the first cycle to the ninth cycle) were not used to calculate the average coulombic efficiency was that the coulombic efficiency could vary in the earlier cycles of charging and discharging. Variations in the coulombic efficiency were suppressed by not using the values of the coulombic efficiency calculated in the earlier cycles of charging and discharging and using only the values of the coulombic efficiency calculated in the later cycles of charging and discharging (the 10th cycle to the 25th cycle) to calculate the average coulombic efficiency. This secured calculation accuracy and reproducibility of the average coulombic efficiency.

TABLE 1

| | | Non- | | Average |
|---|---|---|---|---|
| | Anisole | aqueous | | coulombic |
| | compound | solvent | Molar | efficiency |
| | Kind | Kind | ratio | (%) |
| Comparative example 1 | Formula (1-1) | DME | 0.8 | 0.0 |
| Comparative example 2 | Formula (1-1) | DME | 0.9 | 1.0 |
| Comparative example 3 | Formula (1-1) | DME | 1.0 | 2.0 |
| Comparative example 4 | Formula (1-1) | DME | 1.1 | 5.6 |
| Comparative example 5 | Formula (1-1) | DME | 1.2 | 8.8 |
| Comparative example 6 | Formula (1-1) | DME | 1.3 | 24.6 |
| Comparative example 7 | Formula (1-1) | DME | 1.4 | 38.3 |
| Comparative example 8 | Formula (1-1) | DME | 1.5 | 51.7 |
| Example 1 | Formula (1-1) | DME | 1.6 | 99.2 |
| Example 2 | Formula (1-1) | DME | 1.8 | 99.5 |
| Example 3 | Formula (1-1) | DME | 2.0 | 99.6 |
| Example 4 | Formula (1-2) | DME | 2.0 | 99.4 |
| Example 5 | Formula (1-4) | DME | 2.0 | 99.5 |
| Example 6 | Formula (1-5) | DME | 2.0 | 99.4 |
| Example 7 | Formula (1-7) | DME | 2.0 | 99.3 |
| Comparative example 9 | — | DME | — | 98.5 |
| Comparative example 10 | — | ANS | — | 0.0 |

As indicated in Table 1, the average coulombic efficiency varied depending on the configuration of the electrolytic solution.

Specifically, when the solvent included only the non-aqueous solvent (DME) (Comparative example 9), the average coulombic efficiency increased. When the solvent included only the non-aqueous solvent (ANS) (Comparative example 10), the average coulombic efficiency markedly decreased.

In contrast, when the solvent included the anisole compound and the non-aqueous solvent (DME) (Examples 1 to 7 and Comparative examples 1 to 8), the average coulombic efficiency varied depending on the molar ratio.

Specifically, when the molar ratio was less than 1.6 (Comparative examples 1 to 8), the average coulombic efficiency markedly decreased. However, when the molar ratio was 1.6 or greater (Examples 1 to 7), the average coulombic efficiency markedly increased. More specifically, when the molar ratio was 1.6 or greater (Examples 1 to 7), the average coulombic efficiency further increased as compared with a case where the solvent included only the non-aqueous solvent (DME) (Comparative example 9).

In particular, when the molar ratio was 1.6 or greater, the following tendencies were obtained. Firstly, high average coulombic efficiency was obtained independently of the kind of the anisole compound. Secondly, when the anisole compound included a fluorine group or a chlorine group as a halogen group, high average coulombic efficiency was obtained. Thirdly, when the molar ratio was 2.0 or greater, the average coulombic efficiency further increased.

Based on the results indicated in Table 1, when the electrolytic solution included the anisole compound and the non-aqueous solvent, and the molar ratio was 1.6 or greater, high average coulombic efficiency was obtained. The charging and discharging characteristic was thus improved, and a superior battery characteristic was thus obtained.

Although the present technology has been described above with reference to some embodiments including Examples, the configuration of the present technology is not limited thereto, and is therefore modifiable in a variety of ways.

For example, the description has been given of the case where the secondary battery has a battery structure of the laminated-film type. However, the battery structure of the secondary battery is not particularly limited, and may be, for example, of a cylindrical type, a prismatic type, a coin type, or a button type.

Further, the description has been given of the case where the battery device has a device structure of a wound type. However, the device structure of the battery device is not particularly limited, and may be, for example, of a stacked type or a zigzag folded type. In the stacked type, the positive electrode and the negative electrode are alternately stacked on each other with the separator interposed therebetween. In the zigzag folded type, the positive electrode and the negative electrode are opposed to each other with the separator interposed therebetween, and are folded in a zigzag manner.

Further, although the description has been given of the case where the electrode reactant is lithium, the electrode reactant is not particularly limited. Specifically, the electrode reactant may be another alkali metal such as sodium or potassium, or may be an alkaline earth metal such as beryllium, magnesium, or calcium, as described above. In addition, the electrode reactant may be another light metal such as aluminum.

The effects described herein are mere examples, and effects of the present technology are therefore not limited to those described herein. Accordingly, the present technology may achieve any other suitable effect.

Note that the present technology may have any of the following configurations according to an embodiment.

<1>

A secondary battery including:
a positive electrode;
a negative electrode; and
an electrolytic solution, in which
the electrolytic solution includes
   an anisole compound represented by Formula (1), and
   a non-aqueous solvent, and
a molar ratio of the anisole compound to the non-aqueous solvent is 1.6 or greater,

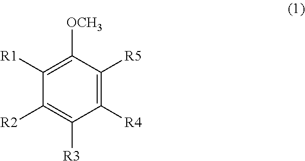

where
each of R1, R2, R3, R4, and R5 is any one of a hydrogen group, a halogen group, or a halogenated alkyl group, and
at least one of R1, R2, R3, R4, or R5 is either the halogen group or the halogenated alkyl group.
   <2>

The secondary battery according to <1>, in which the molar ratio is 2.0 or greater.

<3>

The secondary battery according to <1> or <2>, in which the halogen group includes a fluorine group, a chlorine group, or both.

<4>

The secondary battery according to any one of <1> to <3>, in which carbon number of the halogenated alkyl group is 5 or less.

<5>

The secondary battery according to any one of <1> to <4>, in which the non-aqueous solvent includes a carbonic-acid-ester-based compound, an ether, or both.

<6>

The secondary battery according to <5>, in which each of the carbonic-acid-ester-based compound and the ether is a chain compound.

<7>

The secondary battery according to any one of <1> to <6>, in which the secondary battery includes a lithium secondary battery.

<8>

An electrolytic solution for a secondary battery, the electrolytic solution including:
an anisole compound represented by Formula (1); and
a non-aqueous solvent, in which
a molar ratio of the anisole compound to the non-aqueous solvent is 1.6 or greater,

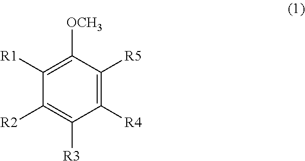

where
each of R1, R2, R3, R4, and R5 is any one of a hydrogen group, a halogen group, or a halogenated alkyl group, and
at least one of R1, R2, R3, R4, or R5 is either the halogen group or the halogenated alkyl group.

### REFERENCE SIGNS LIST

21 . . . positive electrode
22 . . . negative electrode

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a positive electrode;
a negative electrode; and
an electrolytic solution, wherein
the electrolytic solution includes
an anisole compound represented by Formula (1), and
a non-aqueous solvent, and
a molar ratio of the anisole compound to the non-aqueous solvent is 1.6 or greater, 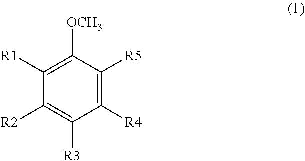
where
each of R1, R2, R3, R4, and R5 is any one of a hydrogen group, a halogen group, or a halogenated alkyl group, and
at least one of R1, R2, R3, R4, or R5 is either the halogen group or the halogenated alkyl group.

2. The secondary battery according to claim 1, wherein the molar ratio is 2.0 or greater.

3. The secondary battery according to claim 1, wherein the halogen group includes a fluorine group, a chlorine group, or both.

4. The secondary battery according to claim 1, wherein a carbon number of the halogenated alkyl group is 5 or less.

5. The secondary battery according to claim 1, wherein the non-aqueous solvent includes a carbonic-acid-ester-based compound, an ether, or both.

6. The secondary battery according to claim 5, wherein each of the carbonic-acid-ester-based compound and the ether is a chain compound.

7. The secondary battery according to claim 1, wherein the secondary battery comprises a lithium secondary battery.

8. An electrolytic solution for a secondary battery, the electrolytic solution comprising:
an anisole compound represented by Formula (1); and
a non-aqueous solvent, wherein
a molar ratio of the anisole compound to the non-aqueous solvent is 1.6 or greater, 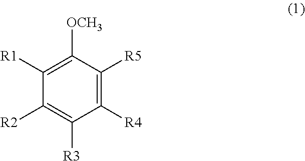
where
each of R1, R2, R3, R4, and R5 is any one of a hydrogen group, a halogen group, or a halogenated alkyl group, and
at least one of R1, R2, R3, R4, or R5 is either the halogen group or the halogenated alkyl group.
